(19) United States
(12) Patent Application Publication
(10) Pub. No.: US 2012/0138439 A1
(43) Pub. Date: Jun. 7, 2012

(54) ELECTRONIC DEVICE WITH BUTTONS

(75) Inventor: JIN-SHI LAI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 12/982,908

(22) Filed: Dec. 31, 2010

(30) Foreign Application Priority Data
Dec. 4, 2010 (CN) 201010573311.9

(51) Int. Cl. H01H 13/76

(52) U.S. Cl. 200/5 A

(57) ABSTRACT

An electronic device includes a housing, a button mechanism fixed to the housing, a switch circuit, at least two switches and at least one support. The button mechanism includes a button body, at least two buttons integrated on the button body, and a stopper formed between every each two adjacent buttons. The switches are covered by the button mechanism and connect to the switch circuit. The at lease one support is fixed to the housing and one of the at least one support is positioned between two adjacent switches. When one of the buttons is pressed, the pressed button activates the corresponding switch and the adjacent support of the switch resists the adjacent stopper of the pressed button.

### BACKGROUND

1. Technical Field

The present disclosure relates to an electronic device with buttons.

2. Description of Related Art

Buttons for an electronic device are usually integrated together, such as volume control buttons of MP3/MP4. However, when the buttons are integrated together, if one of the buttons is pressed, the adjacent button may also be activated, thereby causing an operation fault in the electronic device.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of an electronic device with buttons in accordance with an exemplary embodiment.

FIG. 2 is an exploded view of button area of the electronic device of FIG. 1.

FIG. 3 is a schematic view of the electronic device of FIG. 1 when the back cover of the electronic device is removed.

### DETAILED DESCRIPTION

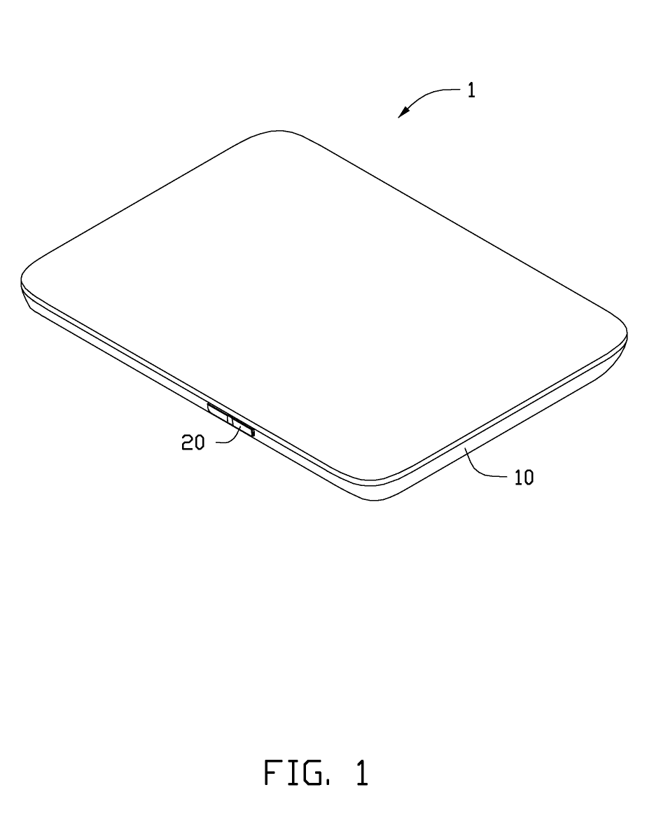

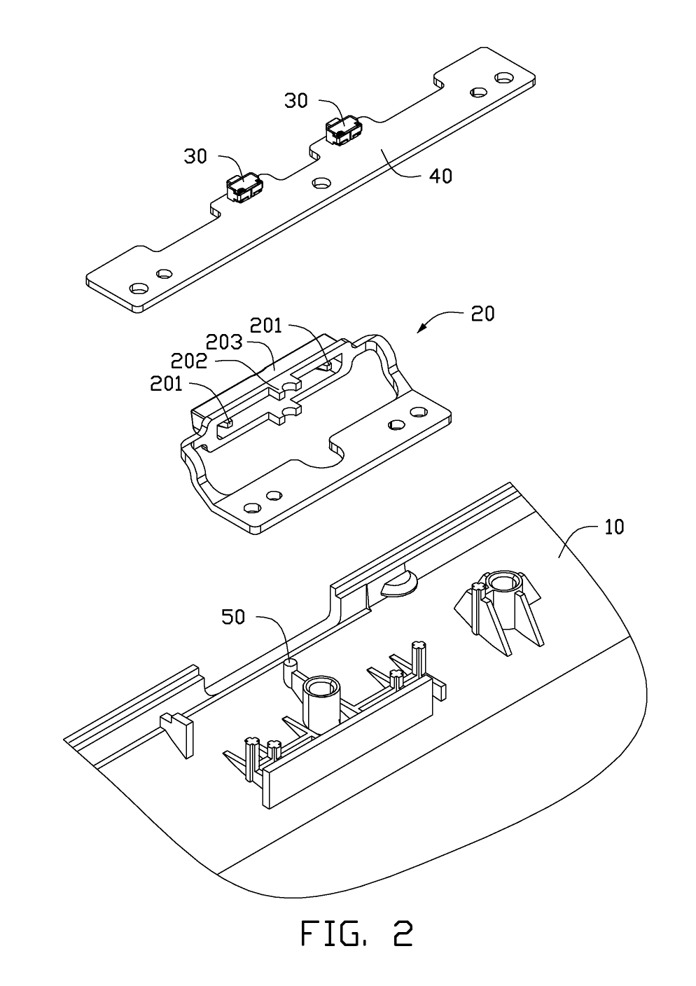

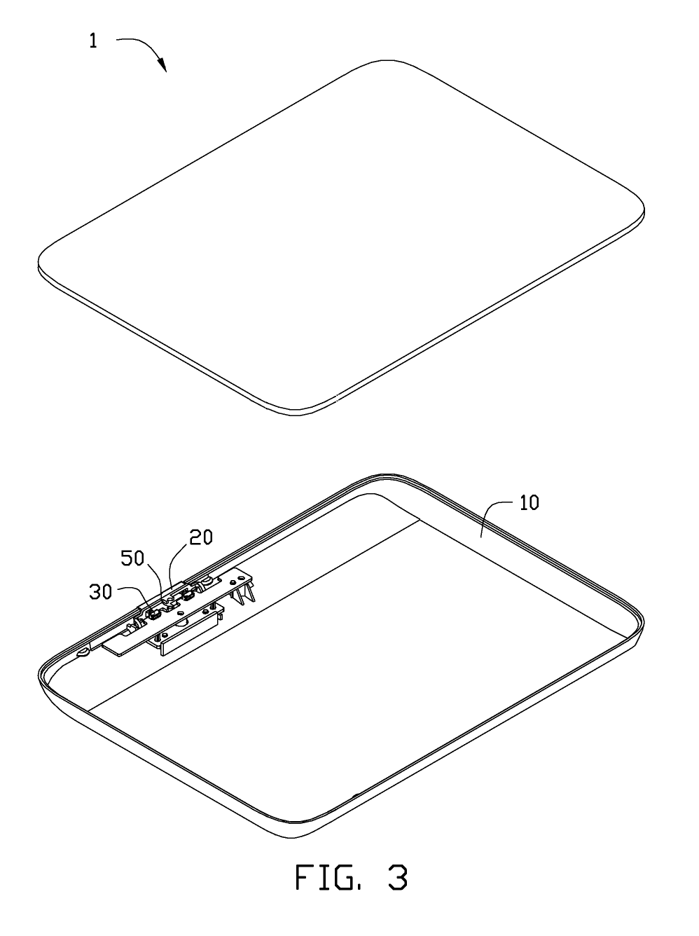

Referring to FIGS. 1-3, an electronic device 1 with buttons (hereinafter “electronic device”) includes a housing 10, a button mechanism 20, at least two switches 30, a switch circuit 40, and at least one support 50. The button mechanism 20 is fixed to the housing 10 and is made of elastic material, such as ABS. The button mechanism 20 includes a button body 203 and at least two buttons 201. The buttons 201 are integrated on the button body 203. In this embodiment, the buttons 201 protrude downwards from the button body 203. A stopper 202 is formed between every each two adjacent buttons 201.

The supports 50 is fixed to the housing 10. One support 50 positioned between every each two adjacent switches 30. The switches 30 are connected to the switch circuit 40. When the switch 30 is pressed, a predetermined function for the switch 30 is active or disable. The button mechanism 20 covers the switches 30. Each button 201 corresponds to one switch 30. When one of the buttons 201 is pressed, the pressed button 201 activates the corresponding switch 30. The adjacent support 50 of the switch 30 resists the adjacent stopper 202 of the pressed button 201. Thereby, the adjacent stopper 202 cannot be moved with the pressed button 201. Thus the adjacent button 201 of the adjacent stopper 202 also cannot be moved and the adjacent switch 30 of the support 50 cannot be activated. Thus, the false operation caused by the union of the buttons is reduced.

In this embodiment, the button mechanism 20 includes two buttons 201 and can be used as the volume control button of MP3/MP4.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An electronic device comprising
a housing;
a button mechanism fixed to the housing, comprising
a button body;
at least two buttons integrated on the button body; and
a stopper formed between every each two adjacent buttons;
a switch circuit;
at least two switches covered by the button mechanism and connected to the switch circuit, each switch corresponding to one of the at least two buttons; and
at least one support fixed to the housing and one of the at least one support positioned between two adjacent switches;
wherein when one of the at least two buttons is pressed, the corresponding switch of the button is activated by the pressed button, the adjacent support of the switch resists the adjacent stopper of the pressed button.

2. The electronic device as described in claim 1, wherein the button mechanism is made of elastic material.

3. The electronic device as described in claim 2, wherein the material for making the button mechanism is Acrylonitrile Butadiene Styrene (ABS).

4. The electronic device as described in claim 1, wherein the at least two buttons protrude from the button body downwards.
